(19) United States
(12) Patent Application Publication
(10) Pub. No.: US 2016/0261715 A1
(43) Pub. Date: Sep. 8, 2016

(54) SYSTEM AND METHOD FOR SECURING A WEB SERVER

(71) Applicant: SENTRIX WEB TECHNOLOGIES LTD., Kfar Neter (IL)

(72) Inventors: Nimrod LURIA, Netanya (IL); Israel Barak, Mevasseret Zion (IL)

(21) Appl. No.: 14/639,144

(22) Filed: Mar. 5, 2015

(51) Int. Cl. H04L 29/08; H04L 29/06

(52) U.S. Cl. CPC H04L 67/327; H04L 67/42; H04L 67/02

(57) ABSTRACT

A system and method for automatically hardening a source web server are provided. The system and method may include analyzing a source web server to identify legitimate information provided by a source web server. Legitimate information may be used to configure a target web server such that the target web server only provides legitimate content in response to requests received from users.

### BACKGROUND OF THE INVENTION

1. Field of the Invention

The present invention relates generally to securing a web server. More specifically, the present invention relates to methods, devices and systems for replication and hardening of a source web server.

2. Description of the Related Art

Websites are known in the art. Generally, a website includes a set of documents or objects known as webpages served by a server computer known as a web server. Otherwise described, a website is hosted by a web server. A web server is typically accessible via a network, e.g., the internet. Webpages may be formatted according to the Hypertext Markup Language (HTML) and served using the Hypertext Transfer Protocol (HTTP). Other file or document formats and transport protocols are known and used. Web pages in a web site are typically accessed using a Uniform Resource Locator (URL). A web browser may be any application or device used for interacting with content or functions provided by a website or web server, e.g., downloading and presenting web pages.

A link as referred to in the art may be a URL (or any other pointer or reference) that, when clicked on, causes a web browser to retrieve the web page or other content pointed to by the link. Any content may be accessed, retrieved or downloaded by a web browser. For example, web pages, images, multimedia content and applications (e.g., Java scripts) may be downloaded from a website or web server.

The need to secure websites (or web servers) is well understood in the art. Known systems and methods secure the communication with websites or web servers (e.g., using Secure Sockets Layer (SSL)). Other systems and methods analyze and/or filter network traffic to/from a website or web server. Some known systems and methods periodically check or verify the integrity of content in a website or web server. Other means such as firewalls and intrusion detection are also known.

However, known systems and methods suffer from various disadvantages. For example, firewalls and/or analyzing network traffic to/from a website or web server may require substantial computational resources and may further slow the interaction with the website or web server. In addition, protecting content stored in a website or web server from being modified by unauthorized entities may not be achieved by known security measures.

### SUMMARY OF THE INVENTION

In one aspect, the invention is directed to a system and method for automatically hardening a source website or a source web server. The system and method according to the invention may include analyzing a source web server to identify or determine legitimate interactions. The identified legitimate interactions may be included in a target web server. A request sent to the source web server may be redirected or otherwise provided to the target web server. The target web server may use information in the target web server to generate and provide a response to the request.

In another aspect, the invention is directed to a computer-implemented method for automatically hardening a source web server, comprising analyzing information provided by the source web server to determine structure and content related to legitimate interactions; wherein said structure and content are usable to cause a target web server to only service the legitimate interactions.

Analyzing a source web server may include determining a logic used for generating a response, determining a risk level associated with the logic and selecting to include the logic in the target web server based on the risk level. A system and method may include determining a response only includes static information, including the static information in the target web server and using the static information, by the target web server, to generate a response for a request.

A system and method may include parsing, by the target web server, a request sent to the source web server, determining an operation required in order to generate a response for the request, determining a risk level associated with the operation and selecting to forward the request to the source web server based on the risk level.

A system and method may include selecting, by the target web server, to modify a request based on the risk level to generate a modified request, forwarding the modified request to the source web server, receiving a response from the source web server and providing the response by the target web server. Analyzing a source web server may be done using credentials of a selected user.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a high level block diagram of an exemplary computing device according to some embodiments of the present invention;

FIG. 2 shows an exemplary system according to some embodiments of the present invention; and

FIG. 3 is a flow diagram depicting embodiments of the present invention.

It will be appreciated that, for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

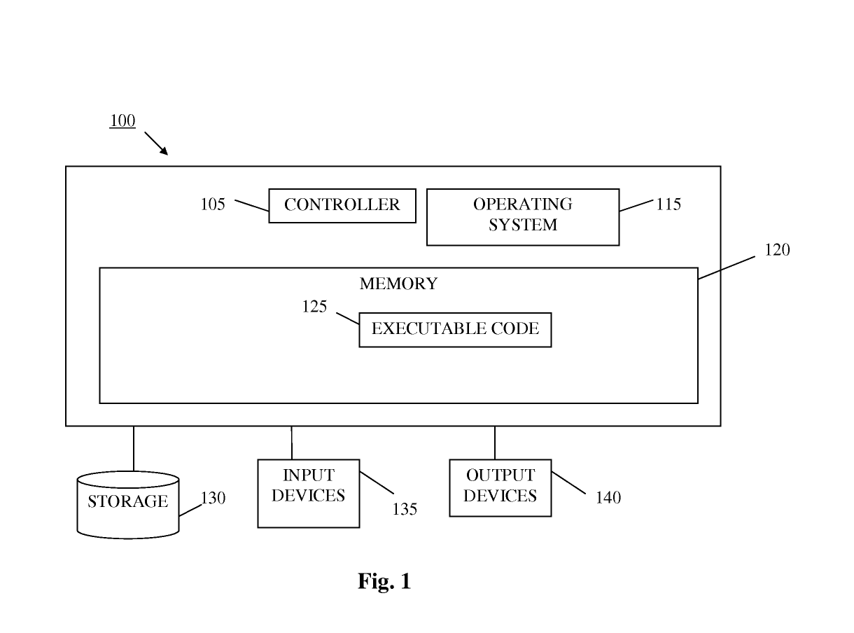

Reference is made to FIG. 1, showing a high level block diagram of an exemplary computing device 100 according to some embodiments of the present invention. Computing device 100 may include a controller 105 that may be, for example, a central processing unit processor (CPU), a chip or any suitable computing or computational device, an operating system 115, a memory 120, a storage 130, input devices 135 and output devices 140.

Operating system 115 may be or may include any code segment designed and/or configured to perform tasks involving coordination, scheduling, arbitration, supervising, controlling or otherwise managing operation of computing device 100, for example, scheduling execution of software programs or enabling software programs or other modules or units to communicate. Operating system 115 may be a commercial operating system. Accordingly, modules or units that include (or share) at least controller 105, memory 120 and executable code 125 as described herein may readily communicate and share data or otherwise interact.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different, memory units. Memory 120 may be a computer or processor non-transitory readable medium, or a computer or processor non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be an application that maintains a target website or target web server as described herein.

Storage 130 may be or may include, for example, a hard disk drive, a floppy disk drive, a Compact Disk (CD) drive and media, a CD-Recordable (CD-R) drive and media, a universal serial bus (USB) device or other suitable removable and/or fixed storage unit. Content may be stored in storage 130 and may be loaded from storage 130 into memory 120 where it may be processed by controller 105. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), printer, a display, a universal serial bus (USB) device or external hard drive may be included in input devices 135 and/or output devices 140.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein, for example, a storage medium, such as memory 120, computer-executable instructions, such as executable code 125, and a controller, such as controller 105.

A system according to some embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a mobile computer, a laptop computer, a server computer, a network device, or any other suitable computing device.

A system, modules or units described, or referred to herein, may include elements included in device 100 described herein. For example, a system that maintains a target web server based on attributes of a source web server as described herein may include a controller 105, a memory 120, and an executable code 125.

A plurality of executable code segments similar to executable code 125 may be loaded into memory 120 and executed by controller 105. For example, a system that maintains a target web server as described herein may include maintenance module that maintains the target web server and a redirection module that intercepts requests destined to a source web server and redirects the intercepted requests to a target web server.

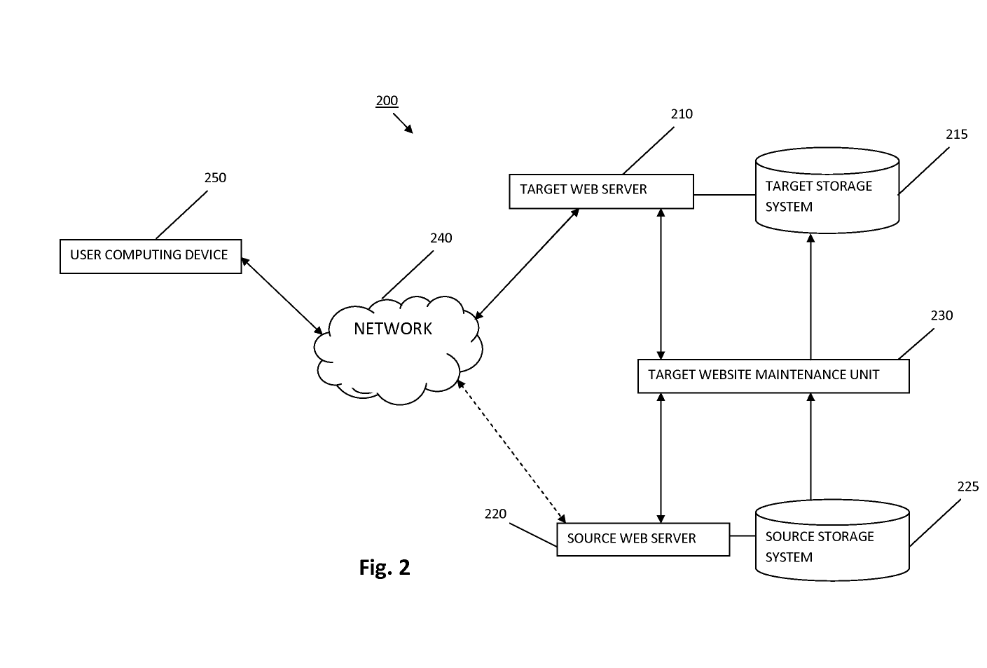

Reference is made to FIG. 2, a high level block diagram of an exemplary system 200 according to some embodiments of the present invention. As shown, system 200 may include, or be connected to, a target web server 210, a target storage system 215, source web server 220, a source storage system 225, a target web server maintenance unit (TWMU) 230, a network 240 and a user computing device 250. The terms “website” and “web server” as used herein may refer to the same thing or entity and may be used herein interchangeably. For example, a web site as referred to herein may mean a web server that hosts a web site.

Target web server 210 may be a server accessible on the internet (or on the cloud). As described, an automated method performed by a system according to embodiments of the invention may create or replicate a version of a source web server on the cloud. For example, a front end (e.g., source web server 220 or other server) may be replicated in the cloud or in a demilitarized (DMZ) network as known in the art. It will be understood that any server may be used as a source web server and any applicable server may be used as a target website or target server as described herein. For example, source web server 220 may be a commercial server or it may be a server in an organization. Target web server 210 may be any server on the internet, in a DMZ or in a data center.

Target web server 210, source web server 220, TWMU 230 and user computing device 250 may be devices similar to computing device 100 or they may include components of computing device 100. For example, Target web server 210 and source web server 220 may be, or may include components of, web servers as known in the art. For example, Target web server 210 and source web server 220 may be a server computers having installed thereon a web server application (e.g., an Internet Information Server (IIS), provided by Microsoft). Although TWMU 230 is shown as a separate unit or device, other configurations may be contemplated. For example, TWMU 230 may be a software module included in Target web server 210 or in source web server 220. TWMU 230 may communicate with Target web server 210 and source web server 220 as shown. Communication between TWMU 230, Target web server 210 and source web server 220 may be over dedicated or private communication channels or it may be over network 240. For example, secured channels may be used to facilitate communication between TWMU 230, Target web server 210 and source web server 220.

User computing device 250 may be a home computer, a laptop, a smartphone, a mobile device or any suitable computing device enabling at least internet access. Network 240 may be any network that enables Target web server 210, source web server 220, TWMU 230 and user computing device 250 to communicate. For example, network 240 may be the internet. As shown, source web server 220 may be operatively connected to source storage system 225 and Target web server 210 may be operatively connected to target storage system 215. Source storage system 225 and target storage system 215 may include hard disk drives or any other storage systems or units suitable for storing web servers' data and logic.

An embodiment of the invention may store, in a target website or in a target web server, content and logic corresponding to a source website or source web server. In an embodiment, a web browser attempting to accesses the source web server is automatically and seamlessly redirected to the target web server. The target web server may be impervious to attacks as further described herein. Accordingly, embodiments of the invention provide hardening of a source web server without requiring modification of the source web site or placing a firewall in front of the source web site or filtering of requests sent to the source web site. Hardening a web site as referred to herein (and as known in the art) may relate to the process of securing a web site, reducing a web site's vulnerability or otherwise enhancing the security of the web site.

For example, TWMU 230 may analyze source web server 220 to identify or determine services and/or information provided by source web server 220 in response to requests and configure Target web server 210 to provide information or services provided by source web server 220. TWMU 230 may interact with source web server 220 identify or determine services and/or information provided by source web server 220 in response to requests. To identify content and logic in source web site 220, TWMU 230 may be configured to send requests to source web server 220, receive responses from source web server 220 and store the responses in target storage system 215. TWMU 230 may be configured to retrieve data from source storage system 225 and store retrieved data in target storage 215. In an embodiment, TWMU 230 may provide content or logic obtained from source web site 220 to a unit or module in target web site 210 and the unit may store content or logic in target storage system 215. For example and as known in the art, a web server application (e.g., target web server 210) may receive content and store received content. Accordingly, TWMU 230 may use services provided by target web server 210 in order to store content in target storage system 215.

TWMU 230 (or another unit, not shown) may intercept or redirect requests sent to source web server 220 (e.g., requests sent from user computing device 250 to source web server 220), and send or redirect the requests to Target web server 210. Target web server 210 may process requests, generate responses and send the responses, e.g., to user computing device 250.

As described, TWMU 230 may analyze source web server 220. Analysis of a source web server may include analyzing a webpage (or HTML page as referred to in the art) in order to determine if the webpage is static or dynamic. It will be understood that any method, protocol or format may be used to encode and transmit webpages or other data objects, e.g., between a web server and a web browser or other web application. For example, content received, processed and stored by TWMU 230 may be encoded and communicated according to the Extensible Markup Language (XML) or it may generated according to the JSON standard or any other protocol as known in the art. Accordingly, the scope of the invention is not limited by the type, format, encoding, protocol or other attributes related to webpages or other content received, processed, provided and stored by TWMU 230, source web server 220 and target web site 210 as described herein.

Generally, a static webpage may be a webpage that has, or includes, static content. Static content may be content that does not change based on a request. An example of a static webpage maybe a webpage that only includes an image. Accordingly, the content served to a user who requests a static webpage may be known in advance. Typically, other than a request for the page, no user input is required in order to serve a static webpage.

TWMU 230 may use a URL to retrieve a webpage from source web server 220 (e.g., a webpage stored in source storage system 222) analyze the retrieved webpage, determine the webpage is static and store the static webpage on Target web server 210 (e.g., in target storage system 215). For example, TWMU 230 may analyze the HTML code associated with a webpage and determine the webpage is static based on the HTML code. TWMU 230 may analyze the Document Object Model (DOM) of a webpage and determine the webpage is static based on the DOM of the page. Although HTML is mainly discussed herein, it will be understood that any other standard, convention, language or protocol for structuring, generating, communicating and presenting content may be used, for example, HTMLS or JavaScript Object Notation (JSON) may be used as known in the art. It will be understood that the scope of the invention is not limited by the standard or protocol used for transmitting, communicating, presenting, structuring, storing and generating content as described herein.

A JavaScript or Java object may be an object created using the Java computer programming language and may enable interactive functionalities within a web browser. For example, if, examining a DOM of a webpage TWMU 230 detects the webpage includes a JavaScript, TWMU 230 may determine the webpage is a dynamic webpage and not a static one since the Java object may generate or modify content that may not be known in advance.

In another example, if, analyzing a DOM of a webpage TWMU 230 determines that the webpage includes input fields or boxes, TWMU 230 may determine the webpage is a dynamic webpage and not a static one since input provided by users may alter, determine or otherwise affect the content of the webpage served to the users. In another case, processing a DOM or HTML code of a webpage TWMU 230 determines that the webpage only includes an image, TWMU 230 may determine the webpage is a static webpage since the image is the only content served when the webpage is requested. Once a static webpage is stored on Target web server 210 it may be served, by Target web server 210, to users or surfers requesting the webpage.

A static webpage may change or be updated. For example, static webpage on source web server 220 may be updated or replaced by the operator or owner of source web server 220. TWMU 230 may periodically (e.g., every few days, hours or minutes) scan webpages or other content in source web server 220 and update Target web server 210 such that static webpages or static web content is up to date, accurately reflecting the static webpages or static web content stored by source web server 220. TWMU 230 may scan source web server 220 based on a command received from a management unit (not shown) or an administrator. Requests for static content sent to source web server 220 may be intercepted and/or redirected to Target web server 210 that may respond by serving the static content to the requesting user or device.

Scanning a web server or scanning webpages or other content in a web server may include retrieving webpages or other content in the scanned web server using associated URL's, analyzing the retrieved content (e.g., examining associated HTML code or DOM) to generate an analysis result. Based on an analysis result, the type (e.g., static or dynamic), last modification time, or other attributes or parameters of a webpage may be determined and various actions may be made. As known in the art, a website may include a home page that may be a special webpage that serves as an introductory of, or entrance point to a website. A home page may include a table of contents or a tree that may be used to access any object served by the web server. Scanning a web server as referred to herein may include traversing a tree or table of content and retrieving webpages of the website or web server. For example, TWMU 230 may perform an automated scan of source web server 220 by retrieving the home page of source web server 220 and use it to traverse all content of source web server 220. Based on a configuration, TWMU 230 may only scan a portion of source web server 220.

For example, TWMU 230 may use a URL to retrieve a webpage from source web server 220, analyze a webpage to produce analysis results and the analysis results may be used to determine the webpage is static and was changed three hours ago. Either using an internal table or by accessing the corresponding webpage on Target web server 210, TWMU 230 may determine that the webpage needs to be updated on target web server 220, e.g., since it was last copied from source web server 220 to Target web server 210 five hours ago. Any method or system known in the art may be used to update a target web server. For example, an update may be done based on a change log, a trigger or timer or an update may be a scheduled task that runs periodically.

It is noted that serving static content from Target web server 210 as described is not caching as known in the art. Caching as known in the art includes storing in a cache content served to a surfer in a first response and re-serving the content from the cache in response to subsequent requests. However, caching includes serving the content at least once from a source or original server to a user. In contrast, embodiments of the invention enable only serving content to users from a target web server (e.g., target web server 210) thus protecting, shielding or hardening a source web server (e.g., source web server 220). For example, in some embodiments or scenarios, source web server 220 is never accessed by surfers or users operating user devices such as user computing device 250 (also known in the art as surfers or web surfers) rather, content is only served to surfers from Target web server 210 thus source web server 220 is completely protected from hackers as, other than authorized users (e.g., an Administrator), source web server 220 may only be accessed by, or provides content to, TWMU 230.

Based on an analysis result, TWMU 230 may determine a webpage's type semi-static or that the webpage includes, contains or is associated with a set of static resources, content objects or webpages. For example, based on an analysis result, TWMU 230 may identify that a webpage includes receiving a number of possible user inputs (e.g., in a drop-down or pull-down menu). For example, based on analyzing HTML code of a webpage TWMU 230 may determine that a request for a webpage includes accepts user input or parameters used to choose one of a set of predetermined responses to return to the user.

An example is a website or web server that displays data related to different countries. The website's main page may include a control (e.g., list box, combo box, etc.) that allows a user to choose a country name from a predefined list. When the user makes a choice, the webpage is configured to display information for the chosen country.

Since the set of countries that may be chosen in the above example is known in advance as is the set of content objects to be presented for each country, TWMU 230 may determine that the webpage and associated content objects are a set of static resources or objects. For example, in the above example related to countries, a user cannot request data related to a country that is not on the list. Furthermore, once the user has chosen a country, the page that will be presented to the user is fully determined. Accordingly, the set of webpages that may be presented with respect to the above example related to countries may be fully determined and may further be stored in a target web server such that the target web server may fully and transparently provide a set of webpages as if they were served by a source web server.

Protecting a source web server by maintaining a target web server may include retrieving a set of static resources or objects from the protected web server, storing the set of objects in the target web server and selectively serving the object by the target web server.

For example, in the above exemplary case related to countries, TWMU 230 may find, e.g., in an HTML code of the webpage, the control that contains the list of countries. TWMU 230 may analyze the control (e.g., parse the list to identify each country in the list). Accordingly, TWMU 230 may identify or determine all possible inputs that may be provided by the user, e.g., the list of possible countries. Therefore, TWMU 230 may identify or determine each possible request related to the webpage. TWMU 230 may generate all possible requests related to a webpage, send the requests to source web server 220, receive responses from source web server 220 and store the responses, in association with the relevant requests, in target server 210.

Provided with all possible requests related to a webpage as well as with all possible responses, target server 210 may fully serve the webpage without accessing source web server 220. For example, in the exemplary case related to countries, an end-user accessing Target web server 210 is presented with the list of countries. When a country is selected, target server 210 returns the correct response using a static responses stored in target storage system 215.

An example of HTML code related to a set of static objects is shown below.

```
<form method=“POST” target=“targetUrl” id=“myform”>
    <select name=“myselect” form=“myform” >
      <option value=“1”>1</option>
      <option value=“2”>2</option>
      <option value=“3”>4</option>
    </select>
    <input type=“submit” value=“Submit”>
</form>
```

Based on analyzing the HTML code above, TWMU 230 may determine there are three different requests that may be generated based on the webpage. TWMU 230 may further send three different or separate “form submit” POST requests to source web server 220 and receive three respective responses. For example, the three requests (and respective responses) may differ based on the content of the “myselect” parameter in the above exemplary code as “myselect” may be one of “1”, “2” and “3”. TWMU 230 may store each of the three requests and received responses in Target web server 210, e.g., by interacting with Target web server 210 or by directly storing the requests and responses on target storage system 215. Provided with all variations of requests that may be generated by a webpage and further provided with all responses for the requests, target web server may fully serve the relevant webpage.

In some cases, not all user inputs can be determined automatically by analyzing the source web server. For example, if a webpage includes a text input field or box and generating a response includes analyzing the text then it may not be possible to determine or identify all possible requests since any text may be entered by the user. For example, instead of a pull-down menu that includes a list of cities, a text input box may be used where a user may type a name of a city.

TWMU 230 may analyze information provided by a source web server to determine structure and content related to legitimate interactions. Legitimate interactions may be interactions that are allowed. Similarly, illegitimate interactions may be forbidden interactions. For example, an interaction that includes requesting and/or providing static content (e.g., a list of city names) may be identified, defined and/or marked as a legitimate or allowed interaction or request. Marking an interaction as forbidden or illegitimate may be, or may include, including the interaction in a black list. Similarly, marking an interaction as legitimate or allowed may include including the interaction in a white list that contains all interactions that are allowed or legitimate. A legitimate interaction may be one that does not involve providing sensitive or confidential content. A legitimate interaction may be one that does not involve modifying content on the source web server. For example, if an interaction involves prompting a user to provide user name and password then TWMU 230 may determine that the interaction is an illegitimate interaction. The structure and content of a webpage may be analyzed in order to determine whether or not requesting the web page or providing the webpage is a legitimate interaction. Any rules or criteria may be used by TWMU 230 in order to determine an interaction is legitimate or illegitimate. Rules and criteria for determining the legitimacy of an interaction may be provided to TWMU 230 and may be used in determining whether or not an interaction is legitimate. For example, a rule may dictate that an interaction involving access to specific folders, files or content is illegitimate. Another rule may dictate that executing a specific application on the source web server renders an interaction illegitimate. For example, if an interaction or request causes executing an application that may provide details of bank accounts then TWMU 230 may identify the interaction as an illegitimate one.

Identifying legitimate structures, interactions and content may be used to cause a target web server to only service legitimate interactions. For example, TWMU 230 may only store content provided by a source web server as a result of legitimate interactions and may further avoid including, in a target web server, any content related to illegitimate interactions. For example, content included in target web server 210 may be content related to legitimate interactions and, accordingly, target web server 210 may only serve content related to legitimate interactions.

As described, logic used for generating responses by source web server 220 may be determined or identified and a risk level may be calculated for the logic. For example, if a request causes source web server to execute logic related to personal details or bank accounts then TWMU 230 may determine that a high risk level is associated with the request and may further select not to include content related to the request in target web server 210. TWMU 230 may be provided with a list or applications defined as risky or sensitive and, upon detecting that an application in the list is called from within a webpage, TWMU 230 may mark the webpage or a request related to the webpage as risky or illegitimate. As described, risky or illegitimate requests may not be supported by target web server 210. For example, content related to risky or illegitimate requests may not be stored in web server 210 thus disabling web server 210 from serving risky or illegitimate requests or interactions. Safe interactions or requests may be identified. For example, if TWMU 230 determines that in order to respond to, or serve a request, only static information is required then TWMU 230 may determine the request is safe or legitimate and may include content used for responding to the safe request in target web server 210.

Although only safe content may be stored in target web server 210, web server 210 may still analyze requests and may selectively forward requests to source web server 220. For example, if target web server 210 cannot respond to a request (e.g., it does not have the content or logic required in order to generate the response), target web server 210 may determine an operation required in order to generate a response for the request (e.g., by analyzing code in a webpage) and may further determine a risk level associated with the request or response. For example, based on a list of applications, files or other content classified as risky or unsafe, target web server 210 may determine that a request is risky or is associated with a high risk level. If target web server 210 determines a request is risky, target web server 210 may select to forward the request to source web server 220 or it may select to ignore the request or otherwise refuse to serve the request. Alternatively or additionally, target web server 210 may modify a request and/or only partially serve a request. For example, if in order to serve a request target web server 210 needs to provide a list of cities and a list of people who lately traveled to those cities, target web server 210 may provide the list of cities but select not to provide a list of names or travelers as requested. For example, the names of the cities may be stored in a file that is safe to provide (e.g., defined as static content) but the list of names may be provided by an application marked (e.g., in a list as described) as unsafe or risky. In such case, target web server 210 may modify the request such that it only includes requesting the names of the cities or target web server 210 may forward the request to source web server 220. Source web server 220 may respond to target web server 210 and target web server 210 may forward the response received from source web server 220 to the user. Accordingly, even in the case of risky interactions, a user may never directly interact with source web server 220.

When detecting a webpage for which not all requests and responses may be determined, TWMU 230 may perform one or more actions. For example, if not all requests and responses for a webpage may be identified, TWMU 230 may record the webpage or a reference to the webpage (e.g., the URL used to retrieve the webpage) in a list and may include the list in a report sent to an administrator. An alert may be generated (e.g., using electronic mail) where an alert may indicate that a webpage cannot be fully supported by Target web server 210 since the set of relevant requests and responses cannot be determined.

In an embodiment, a configuration file may be provided to TWMU 230. For example, a configuration file may include a URL or a webpage and a reference usable for generating requests and responses. For example, in a case were a user can enter a city name in a text box, a list of city names that may be entered in the text box may be provided to TWMU 230, in association with a URL of the webpage. Accordingly, TWMU 230 may generate a set of requests (e.g., using a set of city names) and use them to obtain (e.g., from source web server 220) a respective set of responses (e.g., one for each city) for the webpage. The set of requests and responses may then be stored on Target web server 210. TWMU 230 may further configure Target web server 210 to respond with “city not found” to any request that does not include one of the city names provided to TWMU 230 as described.

Target web server 210 may be configured to respond to requests it cannot serve using a predefined response. For example, Target web server 210 may be configured to respond with “page not found” (e.g., error code 404 as known in the art) when a request is received, Target web server 210 may redirect or block a request. Any known HTTP or other response codes may be returned by Target web server 210 based on a configuration that associates requests with predefined responses. Pre-configuring Target web server 210 with responses as described may enable a system and method to effectively handle attacks. For example, attacks that include sending requests to a server with unknown payload (e.g., zero day attacks known in the art) cannot be effectively handled by known systems and methods that rely on pattern matching or filtering. In contrast, by configuring Target web server 210 to respond with a predefined response to sets, types or categories of requests (e.g., all requests not in a white list, in a black list etc.), attacks such as zero day attacks can be effectively handled.

In an embodiment, TWMU 230 may configure Target web server 210 to forward requests to source web server 220. For example, TWMU 230 may modify a webpage stored in Target web server 210 such that requests for which no response is available in Target web server 210 are forwarded to source web server 220. For example, a webpage stored on Target web server 210 may be configured or modified such that if a city name entered by a user in a text box is not included in a list provided to Target web server 210 then Target web server 210 forwards the request to source web server 220. For example, if a city name in a request received by Target web server 210 is not included in a list of cities provided to Target web server 210 then Target web server 210 may forward the request to source web server 220.

In some cases, not all responses may be available, for example, if not all user inputs can be determined or known in advance. For example, a search function responsive to text entered by a surfer or user into a textbox in a webpage may cause searching a set of documents that may not be known in advance or may require storage capacity that may be expensive. For example, a search query generated based on user input may conceptually search the entire internet for a textual term. In other cases, a response may be generated dynamically or in real-time (e.g., by a Java object embedded in, or associated with, a webpage). As described, a system and method may determine a webpage's type is dynamic (or not static) and may enable handling dynamic webpages in a number of ways. As described, in some cases, a dynamic webpage may be associated with a list of potential inputs or requests and a respective list of responses to be served for the list of requests. In another case, dynamic webpage may be configured to cause Target web server 210 to forward selected requests to a source web server 220. As described, requests may be inspected or analyzed (e.g., by TWMU 230 when updating a target web server or by Target web server 210) an only legitimate requests or transactions may be permitted. For example, based on inspecting a request, TWMU 230 may configure Target web server 210 to respond to the request with a predefined error message. In another case, based on inspecting a request, Target web server 210 may respond to the request with a predefined error message.

In yet other cases, requests may be selectively disabled. For example, a webpage stored in Target web server 210 may be configured to cause Target web server 210 to respond with an error message or other appropriate message (e.g., “webpage not available”) to any request in a black list or any request not included in a white list. For example, in association with a webpage a first set of requests for which Target web server 210 has responses may be included in a white list associated with the page. For example, specific dynamic requests (e.g., requests for which content is dynamically generated) may be included in a white list and Target web server 210 may dynamically generate responses for dynamic requests included in a white list. A second set of possible requests may be included in a black list. Target web server 210 may respond to all requests in the white list by sending a response, may further respond to requests in the black list with a first predefined message and further respond to all other requests using a second predefined message. As known in the art, a webpage may be modified or revised in order to cause specific responses to be provided for specific requests. Accordingly, TWMU 230 may edit or modify webpages (e.g., by modifying HTML code of a webpage as known in the art) in order to configure Target web server 210 to respond as described herein, e.g., TWMU 230 may configure Target web server 210 to respond to a request in a particular way by modifying a webpage and then storing the webpage at Target web server 210.

TWMU 230 may identify flows or sequences of content, e.g., a sequence of webpages downloaded by a web browser from a web server. For example, webpage A may reference webpage B (e.g., by a link) and webpage B may reference webpage C. A flow or sequence may include retrieving webpage A and then retrieving webpage B. An illegitimate flow may be, for example, retrieving webpage A and then retrieving webpage C.

TWMU 230 may configure Target web server 210 according to flows or sequences. For example, a flow may be, or may include a business flow (e.g., an online purchase of service or goods, an online money transaction etc.). TWMU 230 may configure Target web server 210 to allow selected flows, block flows, report when specific flows are attempted etc.

For example, when scanning source web server 220, TWMU 230 may receive a webpage associated with the below HTML code:

```
<form method=“POST” target=“/url2” id=“myform”>
    Search for <input type=“text” value=“mytext”>
    <input type=“submit” value=“Submit”>
</form>
```

As described, TWMU 230 may use received HTML code in order to generate requests that may be sent in relation with the associated webpage. However, receiving the above HTML code, TWMU 230 may not be able to readily know or determine what value to provide for, or substitute with, the parameter “mytext” in the above code when generating requests. TWMU 230 may generate an alert, record an event, block a request, reset a connection or For example, when unable to generate requests for a webpage, TWMU 230 may generate an alert and/or record the event.

Based on an indication provided by TWMU 230, various actions or configurations may take place. For example, TWMU 230 may include the webpage in a black or other special list that may be used as described herein. For example, the relevant webpage and/or URL may be included in a list of webpages for which requests are to be forwarded to source web server 220. For example, rather than storing a webpage as retrieved from source web server 220, TWMU 230 may store a webpage that includes code that causes Target web server 210 to forward all or specific requests to source web server 220. TWMU 230 may further associate the webpage stored on Target web server 210 with the same URL associated with the respective webpage on source web server 220. Accordingly, when the webpage is accessed and/or requests related to the webpage are received by Target web server 210, the requests are automatically forwarded to source web server 220.

A list of webpages for which TWMU 230 was unable to generate requests and/or responses may be examined by an operator and configuration information usable for generating webpages to be stored on Target web server 210 may be generated based on input from the operator. Even if requests are forwarded to source web server 220, source web server 220 may still be protected or shielded from users or surfers. For example, Target web server 210 may forward a request to source web server 220 as described herein, receive a response from source web server 220 and forward or send the response to the requesting user.

As known in the art, a web server may be associated with types, categories or classes of users where each type, class or category of users is associated with permissions. For example, using user name and password, users are identified by source web server 220 and permissions are granted based on the identification. For example, user “A” may be an administrator that, may be granted permission to delete files on source storage 225, user “B” may be a user that is permitted some operations and user “C” may be a user with limited permissions, e.g., a “guest” user only permitted to view public content on source web server 220.

TWMU 230 may scan a source web server or otherwise operate as, or in the context of, a selected user. For example, TWMU 230 may scan a source web server using credentials or privileges of one of: a member, a guest or an administrator and generate a respective target web server that may include content that would be presented or served to a respective one of: a member, a guest or an administrator.

TWMU 230 may automatically identify flows and may identify approved flows or forbidden or restricted flows. For example, by following a link in webpage X to webpage Y, TWMU 230 may identify a flow that includes webpages X an Y. Operating with credentials or permissions of a specific user, TWMU 230 may determine that a flow is allowed for a first user and forbidden of restricted for another user. For example, TWMU 230 may determine that webpage Y can only be accessed by specific users and/or only by reference from webpage X (e.g., a user cannot request webpage Y as the first webpage). Flows and operations allowed may be recorded in Target web server 210 such that only allowed flows and operations are supported.

TWMU 230 may be provided with a user name and password and may scan source web server 220 as, or in the context of, a specific user. For example, TWMU 230 may scan source web server 220 as a guest user (e.g., a user with no special permissions). As described herein, scanning source web server 220 may include obtaining some (or even all) URL's related to source web server 220, using the URL's to generate requests for content objects or webpages associated with the URL's, receiving responses, content objects or webpages and storing the requests, responses, content objects and/or webpages in Target web server 210. Accordingly, if TWMU 230 scans source web server 220 as a guest user, the resulting version of Target web server 210 will be suitable for guest users and Target web server 210 will readily serve guest users substantially the same as source web server 220 would.

TWMU 230 may be provided with any (or a set of) user types, user categories or classes, or any other user information, privileges or credentials, such that TWMU 230 may simulate any type of user when interacting with source web server 220. For example, TWMU 230 may emulate or act as a user with limited privileges or credentials (e.g., a guest user as known in the art). In other cases, using a different configuration, TWMU 230 may emulate or act as a privileged user, e.g., an administrator.

For example, a set of versions of Target web server 210 may be generated by having TWMU 230 scan Target web server 210 as user “A” with a first set of credentials and associated permissions, then as user “B” with a second set of credentials and associated permissions and so on. For example, some webpages presented to user “B” who may be a user that has an account on source web server 220 may not presented to user “A” who may be a guest user. In other cases, specific options in a specific webpage may be presented to user “B” but not to user “B”. Accordingly, the set of requests and responses generated and stored on Target web server 210 may differ based on the user type or identification that TWMU 230 uses when scanning source web server 220. Using different user accounts, privileges or credentials, TWMU 230 may generate different versions of a target web server. Accordingly, a system and method may generate a target web server based on a user type, class or category or other relevant user identification or information.

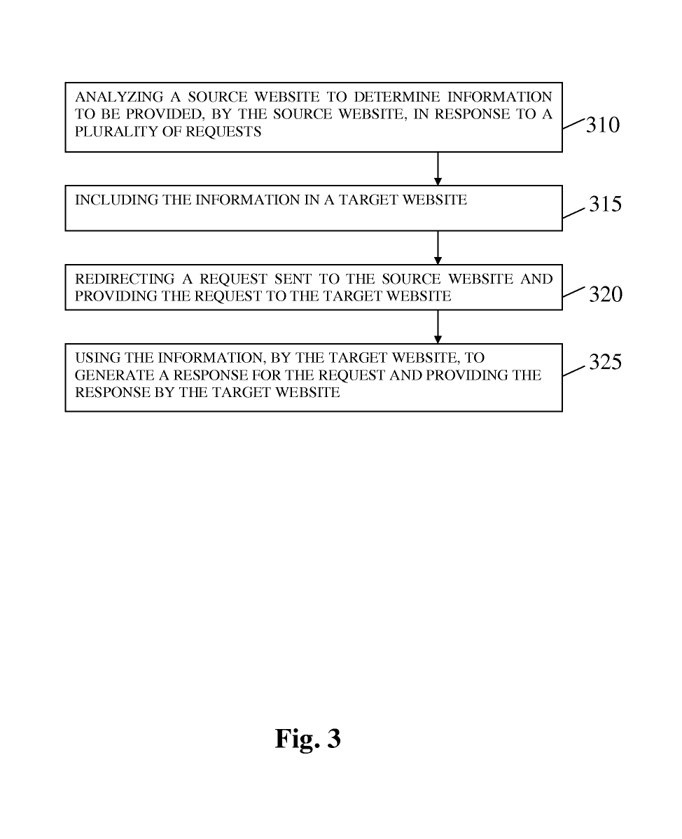

Reference is made to FIG. 3 that shows a flow according to some embodiments of the present invention. As shown by block 310, a method or flow may include analyzing a source web server to determine information to be provided, by the source web server, in response to a plurality of requests. For example TWMU 230 may analyze source web server 220 to determine or identify responses provided by source web server 220 in response to requests received from users. As shown by block 315, a method or flow may include including the information in a target web server. For example, TWMU 230 may store in Target web server 210 information related to source web server 220, e.g., responses provided by source web server 220 may be stored, by TWMU 230, in Target web server 210 such that Target web server 210 may provide responses to users (e.g., instead of source web server 220). As described, by causing Target web server 210 to provide responses to users, source web server 220 may be shielded or protected from users, hackers and the like.

As shown by block 320, a method or flow may include redirecting a request sent to the source web server to the target web server. For example, a unit configured to redirect requests sent to source web server 220 to Target web server 210 may be a proxy as known in the art. In other cases, redirection of requests from source web server 220 to Target web server 210 may be achieved by manipulating domain name service (DNS) tables as known in the art. As shown by block 325, a method or flow may include using the information, by the target web server, to generate a response for a request and providing the response by the target web server. For example, Target web server 210 uses information stored in Target web server 210 by TWMU 230 to generate responses to requests from users.

As described, a system and method according to embodiments of the invention may analyze information provided by a source web server to determine structure and content of, or related to, legitimate interactions. For example, the type of content provided in response to a request and a risk involved with providing the content may be determined by TWMU 230 as described. TWMU 230 may be provided with any rules or logic enabling it to determine whether or not a request or interaction is legitimate, safe to serve or allowed. For example, TWMU 230 may be provided with a list of sensitive content objects that, if requested by a user, cause TWMU 230 to mark, classify or identify the request as illegitimate or forbidden.

Structures and content identified by TWMU 230 may be usable to cause a target web server to only service legitimate interactions. For example, TWMU 230 may only store in target server 220 content related to safe or legitimate requests or interactions. Accordingly, a target server as described herein may freely and safely serve content to users without risking or jeopardizing integrity or security of the source web server. Moreover, since target server 220 may be configured to only serve safe or legitimate requests or interaction, there may be no need to process requests as done by known systems and methods. For example, to safely serve requests, known systems and methods may analyze each request when received, in contrast, by providing a target server that can only serve legitimate or safe to deliver content, performance of a system may be significantly higher while security of a source web server may be maximized. For example, target web server 220 may be configured to only serve content related to legitimate interactions, e.g., by only storing content related to legitimate interactions in target storage system 215.

To identify legitimate interactions, TWMU 230 may analyze a source web server to determine a logic used for generating a response. For example, TWMU 230 may analyze requests and responses sent to and received from source web server 210 and determine or identify logic used for generating responses. TWMU 230 may determine or identify a risk or risk level encountered by providing a response or executing a logic as described herein.

TWMU 230 may select whether or not to include logic in a target web server based on the risk level. For example, if TWMU 230 identifies that a logic (e.g., in a script or program executed with relation to a request) access sensitive information, TWMU 230 may select not to include the logic in target web server 220. For example, TWMU 230 may determine a response only includes static information as described and may select to enable target web server 220 to serve the static information by including the static information in a storage of target web server 220, e.g., in target storage system 215.

Target server 220 may be configured to selectively forward some requests to source web server 210. For example, target web server 220 may parse a request sent to source web server 210 and may determine an operation or logic required in order to generate a response, or may determine which content needs to be accessed in order to generate a response. TWMU 230 may determine or identify a risk level associated with the logic, operation or accessed content. IF the risk level is above a predefined value, TWMU 230 may select to forward the request to source web server 220. Accordingly, a target web server may selectively forward a request to a source web server based on a risk level associated with the request.

In an embodiment, a target web server may be configured to modify a request and forward the modified request to a source web server. For example, based on a risk level identified or determined as described, target web server 210 may modify a request (e.g., remove access to specific content) and forward a modified request to source web server 220.

Requests or other user network traffic destined, or sent to, source web server 220 may be redirected to target web server 210, e.g., using a proxy or by manipulating DNS tables as described herein.

Providing target web server 210 with requests sent to source web server 220 may be done using any system and method as known in the art. For example, a system according to embodiments of the invention may include a first unit (e.g., TWMU 230) configured to analyze a source web server to determine information to be provided, by the source web server, in response to a plurality of requests, and include the information in a target web server. A system according to embodiments of the invention may include a second unit (e.g., a proxy) configured to provide a request sent to the source web server to the target web server.

Some embodiments may be provided in a computer program product that may include a non-transitory machine-readable medium, with stored thereon instructions, which may be used to program a computer, or other programmable devices, to perform methods as disclosed herein. Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including optical disks, compact disk (CD), semiconductor devices such as read-only memories (ROMs), random access memories (RAMs), flash memories, electrically erasable programmable read-only memories (EEPROMs) or any type of media suitable for storing electronic instructions, including programmable storage devices. For example, memory 120 may be a non-transitory machine-readable medium.

A system according to some embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a notebook computer, a workstation, a server computer, a network device, or any other suitable computing device. For example, a system as described herein may include one or more devices such as computing device 100.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A computer-implemented method for automatically hardening a source web server, the method comprising:
analyzing information provided by the source web server to determine structure and content related to legitimate interactions;
wherein said structure and content are usable to cause a target web server to only service the legitimate interactions.

2. The method of claim 1, comprising configuring the target web server to only serve content related to the legitimate interactions.

3. The method of claim 1, comprising:
analyzing the source web server to determine a logic used for generating a response;
determining a risk level associated with the logic; and
selecting to include the logic in the target web server based on the risk level.

4. The method of claim 1, comprising:
determining that a response only includes static information;
including the static information in the target web server; and
generating a response for a request with the target web server using the static information.

5. The method of claim 1, comprising:
parsing, by the target web server, a request sent to the source web server;
determining an operation required in order to generate a response for the request;
determining a risk level associated with the operation; and
selecting to forward the request to the source web server based on the risk level.

6. The method of claim 1, comprising:
selecting, by the target web server, to modify the request based on the risk level to generate a modified request;
forwarding the modified request to the source web server;
receiving a response from the source web server; and
providing the response by the target web server.

7. The method of claim 1, wherein analyzing the source web server comprises:
obtaining a Uniform Resource Locator (URL) associated with a webpage;
generating a request and sending the request to the source web server using the using the URL; and
receiving a response to the request and storing the URL and response in the target web server;

8. The method of claim 7, wherein sending the request is done using credentials of a selected user.

9. The method of claim 8, wherein a type of the target web server is determined by a type of the selected user.

10. The method of claim 1, comprising, identifying a flow of content at the source web server and configuring the target web server according to the flow.

11. The method of claim 1, comprising redirecting user network traffic destined to the source web server to the target web server.

12. A system comprising:
a first unit configured to:
analyze a source web server to determine information to be provided, by the source web server, in response to a plurality of requests, and
include the information in a target web server; and
a second unit configured to:
provide a request sent to the source web server to the target web server;
wherein the target web server is configured to use the information to generate and provide a response for the request sent to the source web server.

13. The system of claim 12, wherein the first unit is configured to:
analyze the source web server to determine a logic used for generating a response;
determine a risk level associated with the logic; and
select to include the logic in the target web server based on the risk level.

14. The system of claim 12, wherein the first unit is configured to:
determine that a response only includes static information; and
include the static information in the target web server;
wherein the target web server is configured to use the static information to generate a response for a request.

15. The system of claim 12, comprising:
parsing, by the target web server, a request sent to the source web server;
determining an operation required in order to generate a response for the request;
determining a risk level associated with the operation; and
selecting to forward the request to the source web server based on the risk level.

16. The system of claim 12, comprising:
selecting, by the target web server, to modify the request based on the risk level to generate a modified request;
forwarding the modified request to the source web server;
receiving a response from the source web server; and
providing the response by the target web server.

17. The method of claim 12, wherein analyzing the source web server comprises:
obtaining a Uniform Resource Locator (URL) associated with a webpage;
using the URL to generate a request and sending the request to the source web server; and
receiving a response to the request and storing the URL and response in the target web server;

18. The method of claim 17, wherein sending the request is done using credentials of a selected user.

19. The method of claim 18, wherein a type of the target web server is determined by a type of the selected user.

20. The method of claim 12, comprising, identifying a flow of content at the source web server and configuring the target web server according to the flow.

21. A system comprising:
a unit configured to:
analyze information provided by the source web server to determine structure and content related to legitimate interactions;
wherein said structure and content are usable to cause a target web server to only service the legitimate interactions.

22. The system of claim 21 wherein the unit is configured to store content related to legitimate interactions in the target web server.
